(19) United States
(12) Patent Application Publication
(10) Pub. No.: US 2014/0198698 A1
(43) Pub. Date: Jul. 17, 2014

(54) System and Method for Filtering Broadcast Messages Received Over a Wireless Local Area Network

(71) Applicant: Per Kristiansson, San Diego, CA (US)

(72) Inventor: Per Kristiansson, San Diego, CA (US)

(73) Assignee: SONY ERICSSON MOBILE COMMUNICATIONS AB, Lund (SE)

(21) Appl. No.: 14/126,046

(22) PCT Filed: Jun. 15, 2011
(86) PCT No.: PCT/IB2011/052608

§ 371 Date: Mar. 6, 2014

(51) Int. Cl. H04W 52/02

(52) U.S. Cl. CPC H04W 52/0206
USPC 370/311

(57) ABSTRACT

A user device configured to communicate with a remote device via a Wireless Access Point (WAP) listens on one or more active ports for data sent by the WAP while in a sleep mode. Upon receiving data, the user device identifies the port over which it received the data and determines whether that port is on a list of active ports. If the port is on the list, a controller in the user device wakes the user device from the sleep mode to process the data. If the port is not on the list, the controller discards the received data and leaves the user device in the sleep mode.

### FIELD OF THE INVENTION

The present invention relates to wireless communication devices in general, and more particularly to wireless communication devices configured to communicate with remote devices via a Wireless Access Point.

### BACKGROUND

The use of wireless technology to facilitate communications is increasingly popular. For example, many homes and businesses now have Wireless Local Area Networks (WLANs) that communicatively link user devices to other remote devices. To link devices, the WLAN typically provides a connection to a Wireless Access Point (WAP) that is connected to the Internet. One such example of a WAP is a Wi-Fi hotspot that operates according to the IEEE 802.xx family of standards.

Currently, WAPs are distributed over a wide geographical area to provide users with the mobility to move around a large coverage area without losing access to the Internet. Although useful, however, some WAP configurations can be problematic for some user devices. For example, user devices that access the Internet via the WAP are often portable and run on limited battery power (e.g., Smartphones, laptop and notebook computers, Personal Digital Assistants (PDAs), and tablet computing devices). Such devices often enter a “sleep mode” or “low-power mode” when not in use to drastically reduce their consumption of electrical current. In the sleep mode, a controller in the device turns off or suspends the delivery of electrical power to certain unneeded electrical components (e.g., a display). When the user wishes to use the device, the device restores the power to those electrical components thereby “waking up” the device.

Besides a user action (e.g., a key press), there are different ways to “wake up” a device from the sleep mode. For example, WAPs commonly broadcast Universal Plug-n-Play (UPnP) or other proprietary messages that force “sleeping” devices to wake-up. The messages may be sent, for example, to inform connected devices of other devices that are being connected and/or disconnected to/from the network. Often times, these broadcast messages have little or no relevance for the device. Nevertheless, the broadcast messages still cause the user devices to wake up and consume large amounts of current in the process. For example, some devices will draw only 5 mA of current while in the sleep mode. Upon receiving a broadcast message, the devices will wake up the sleeping components increasing current consumption to approximately 100 mA. Generally, WAPs can be configured to avoid sending at least some broadcast messages to the devices, but end users are not typically savvy enough to properly configure the WAP operate in this manner.

### SUMMARY

The present invention provides a method and device for reducing power consumption in wireless communication devices operating in a sleep mode or low-power mode by selectively waking the devices. More particularly, a wireless communication device identifies the ports over which it expects to receive messages from a Wireless Access Point (WAP), and then filters the incoming messages from the WAP. Provided the message is received over a port that the device expects to receive data from the WAP, the device wakens to process the message. Otherwise, the device discards the message and remains in the sleep mode.

Therefore, in one embodiment, the present invention provides a method for reducing power consumption in a wireless user device. The method comprises storing a list of one or more allowed ports over which the use device is configured to communicate data with a Wireless Access Point (WAP), determining whether a port over which the user device receives data from the WAP is on the list of allowed ports, and waking the user device from a sleep mode if the port is on the list of allowed ports.

In one embodiment, the method further comprises generating the list of allowed ports to identify the ports over which the user device is listening for incoming data from the WAP.

In one embodiment, the method further comprises dynamically updating the list of allowed ports.

In one embodiment, the method further comprises receiving the generated list of allowed ports at a Wireless Local Area Network (WLAN) circuit at the user device.

In one embodiment, the method further comprises discarding the data received over the port if the port is not on the list of allowed ports, and leaving the user device to operate in the sleep mode after discarding the data.

In one embodiment, the method further comprises identifying the port over which the incoming data is received from the WAP, and filtering the incoming data by comparing the identity of the port to the one or more ports on the list of allowed ports.

The present invention also provides a user device for communicating with remote devices in a Wireless Local Area Network (WLAN). In one embodiment, the user device comprises a communications interface configured to communicate data with a Wireless Access Point (WAP) over one or more allowed ports, a memory configured to store a list of the allowed ports, and a WLAN circuit configured to determine whether a port over which the user device received data from the WAP is on the list of allowed ports stored in the memory, and wake the user device from a sleep mode if the port is on the list.

In one embodiment, the user device further comprises a programmable controller configured to generate the list of allowed ports to identify the one or more ports over which the user device is listening for incoming data from the WAP.

In one embodiment, the programmable controller is further configured to dynamically update the list of allowed ports.

In one embodiment, the WLAN circuit is further configured to receive the generated list of allowed ports from the controller.

In one embodiment, the WLAN circuit is further configured to discard the data received over the port if the port is not on the list of allowed ports, and leave the user device to operate in the sleep mode after discarding the data.

In one embodiment, the WLAN circuit is further configured to identify the port over which the incoming data is received from the WAP, and filter the incoming data by comparing the identity of the port to the one or more ports on the list of allowed ports.

The present invention also provides a method of reducing power consumption in a wireless user device. In one embodiment, the method comprises generating, at a user device, a list identifying one or more restricted ports over which the user device will not listen for incoming data from a Wireless Access Point (WAP), discarding received data if the port over which the data is received is on the list of restricted ports, and leaving the user device in the sleep mode after discarding the data.

In one embodiment, the method further comprises waking the user device from a sleep mode responsive to receiving the data from the WAP if the port is not on the list.

In one embodiment, generating, at a user device, a list identifying one or more restricted ports over which the user device does not listen for incoming data comprises dynamically generating the list of restricted ports based on one or more ports that are not associated with a registered listener.

In one embodiment, the method further comprises receiving the dynamically generated list at a Wireless Local Area Network (WLAN) circuit at the user device, identifying the port over which the incoming data is received from the WAP, and filtering the incoming data by comparing the identity of the port to the one or more restricted ports on the list.

The present invention also provides a user device for communicating with remote devices in a Wireless Local Area Network (WLAN). In one embodiment, the user device comprises a memory configured to store a list of restricted ports that identifies one or more ports over which the user device will not listen for data from the Wireless Access Point (WAP), and a programmable controller configured to generate the list of restricted ports, discard received data if the data is received from the WAP over a port that is on the list of restricted ports, and leave the user device in the sleep mode after discarding the data.

In one embodiment, the programmable controller is further configured to wake the user device from a sleep mode if the port over which the user device received the data is not on the list of restricted ports.

In one embodiment, the controller is further configured to dynamically generate the list of restricted ports based on one or more ports that are not associated with a registered listener.

In one embodiment, the user device further comprises a Wireless Local Area Network (WLAN) circuit configured to receive the dynamically generated list of restricted ports, identify the port over which the data is received from the WAP, and filter the data by comparing the identity of the port that received the data to the ports on the list of restricted ports.

### BRIEF DESCRIPTION OF THE DRAWINGS

FIG. 1 is a block diagram illustrating some exemplary user devices configured to access an IP network via a WAP according to one embodiment of the present invention.

FIG. 2 is flow chart illustrating another method of determining, at a user device that is currently in a sleep mode, whether to awaken according to one embodiment of the present invention.

FIG. 3 is a block diagram illustrating some of the component parts of a user device configured according to one embodiment of the present invention.

FIG. 4 is flow chart illustrating another method of determining, at a user device that is currently in a sleep mode, whether to awaken according to another embodiment of the present invention.

### DETAILED DESCRIPTION

The present invention provides a method and device for reducing power consumption in a wireless user device capable of communicating with remote devices via a Wireless Access Point (WAP) providing access to a communications network. More specifically, the present invention “filters” messages received from the WAP at a user device that is in sleep mode. The filter is independent of the architecture of the user device, and allows only those messages that the user device should process to pass through and awaken the device.

In one embodiment, the user device receives a list of allowed ports over which the device expects to receive data from the WAP. The list of allowed ports is not static, and may change from time to time. Upon receiving a message from the WAP, a “filter” at the user device identifies the port the message was received over and compares that port to the list of allowed ports. Provided the port is on the list, the filter allows the message to pass and the device awakens to process the message. If the port is not on the list, the filter discards the message. The device does not process those messages discarded by the filter, and thus, the present invention reduces power consumption in the user device by allowing the device to remain in sleep mode for those messages.

In another embodiment, the list comprises a list of restricted ports over which the user device does not expect to receive messages from the WAP. In this embodiment, the filter compares the identity of the port over which the message is received to the list of restricted ports. If the port is not on the list, the filter allows the message to pass to awaken the device. If the port is on the list, however, the filter discards the message thereby leaving the user device in the sleep mode and conserving power resources.

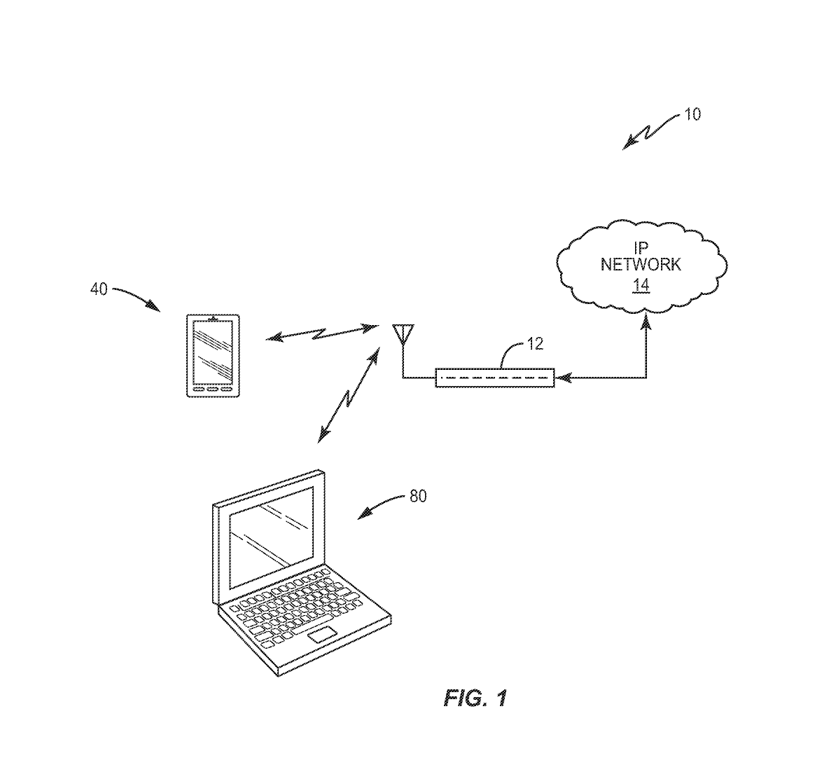

Turning to the drawings, FIG. 1 illustrates a communication system 10 comprising some wireless user devices 40, 80 configured according to one embodiment of the present invention, an IP network 14, and a WAP 12. The functions of the WAP 12 and the IP network 14 are well-known in the art and not germane to the present invention. Thus, a detailed description of these entities is not required for understanding the present invention. It is sufficient to understand that the WAP 12 utilizes any of the IEEE 802.xx family of standards (e.g., Wi-Fi, Bluetooth, or other related standard) to allow the user devices 40, 80 to communicate with the external IP network 14, such as the Internet. Although not specifically shown in the figures, WAP 12 may be configured to connect to a router via a cable or other physical medium to relay the data between the user devices 40, 80 and one or more servers or other devices in the IP network 14. Alternatively, however, the WAP 12 may be configured to also function as a router.

The user devices 40, 80 are configured to wirelessly communicate with the WAP 12 and may be any devices known in the art. FIG. 1 illustrates the devices as being a cellular telephone or a laptop computer. Further, the following description discusses the embodiments of the present invention in the context of user device 40. However, those skilled in the art will readily appreciate that this is for illustrative purposes only. Any portable wireless device able to communicate with the WAP 12 may be configured to conserve its battery resources according to the present invention. Some other exemplary types of devices include, but are not limited to, satellite communication devices, Personal Digital Assistants (PDAs), and tablet computing devices.

As is known in the art, user device 40 may enter a sleep mode whenever it is idle for a predetermined time. During the sleep mode, the user device 40 will shut-down or suspend the operation of any currently un-needed circuits. For example, while idle, the display of user device 40 is not needed by the user. Displays are notoriously power-hungry circuits. Therefore, user device 40 may place into a sleep mode or low-power mode during that idle period to limit the amount of current drawn by that circuit to a minimum. Placing such un-needed circuits into a sleep mode helps to conserve battery power and extend battery life.

While user device 40 is in sleep mode, the WAP 12 may broadcast messages that cause the user device 40 to awaken and possibly process the received message. For example, many WAPs are conventionally configured to broadcast a Universal Plug-n-Play message whenever a device is connected to or removed from the network. Upon receipt of such messages, user device 40 will typically awaken their sleeping circuits to process the message. However, not all user devices are interested in the broadcast messages, nor are their operation affected by the broadcast messages. Further, many WAPs are not configured to send only those messages that the user devices need or are interested in. Therefore, WAP 12 can potentially “awaken” user device 40 from time-to-time by broadcasting messages that the user device 40 may not care about. Of course, waking the user device 40 to process a message that the user device 40 does not care about still causes the user device 40 to needlessly consume power resources. Therefore, as stated previously, the present invention configures the user device 40 to filter the incoming messages and allow only those messages that the user device 40 is interested in to awaken the user device 40 from the sleep mode.

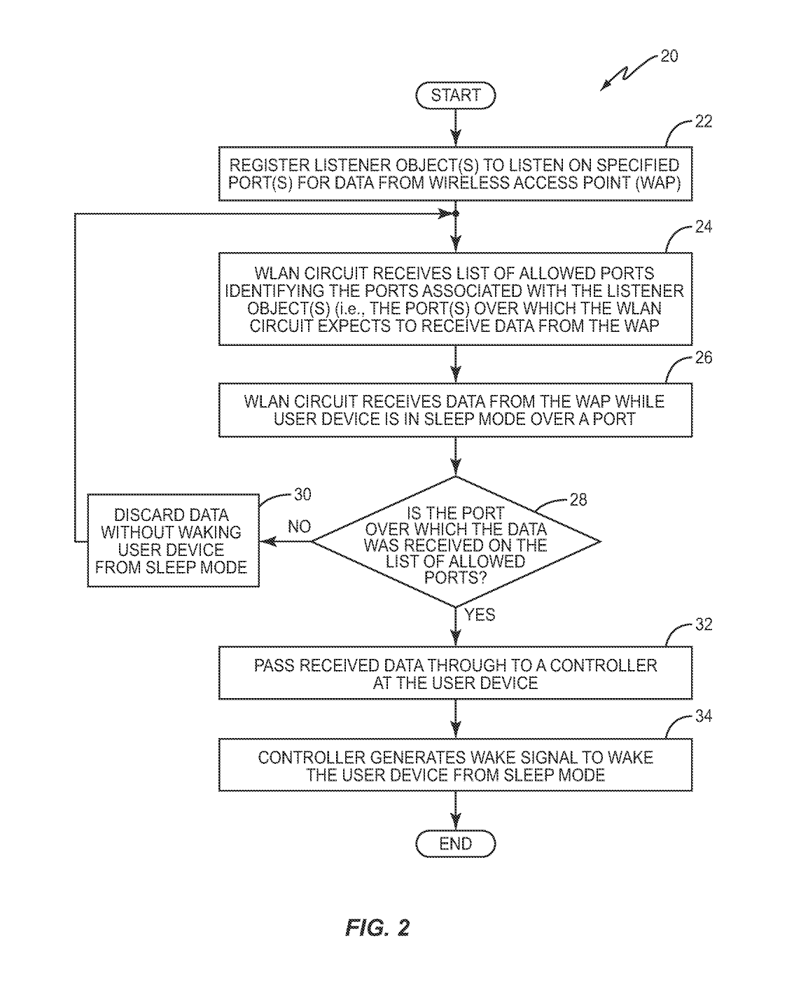

FIG. 2 is a flow diagram of a method 20 illustrating how user device 40 may reduce its power consumption by filtering incoming messages from WAP 12, and allowing only those messages that are germane to the operation of user device 40 to awaken user device 40 from the sleep mode. Method 20 begins with the user device 40 creating and registering one or more event listener objects (box 22). Listener objects and their functions are well-known in the art and are not germane to the present invention. Therefore, they are not described in any detail herein. It is sufficient to understand, however, that the one or more listener objects instantiated on the user device 40 are configured to monitor specified ports on the user device 40 for data being sent from WAP 12. Such data may comprise, for example, notifications of changes or modifications made to the WAP 12, or messages sent to one or more user devices by the WAP 12. By way of example only, such messages and notifications may be UPnP broadcast messages sent to user device 40 over port TCP:5000 UDP:1900. Of course, other messages and notifications may be sent to and received by the user device 40 over different ports.

Once the event listeners are registered, a WLAN chip at the user device is sent a list identifying all ports on user device 40 that are being monitored by the registered one or more listener objects for data being sent by the WAP 12 (box 24). These are the ports over which the user device 40 expects to receive data from the WAP 12. Thereafter, the user device 40 enters the sleep mode. Upon receiving a message from WAP 12, the WLAN chip at the “sleeping” user device 40 intercepts the message prior to a controller at the user device 40 processing the message (box 26). Particularly, the WLAN chip determines the identity of the port over which the message was received and compares the port identity to the list of “allowed” port identities stored in a memory at the user device 40 (box 28). If the port identity

As stated previously, the list of allowed ports is kept in memory of the device 40 and may change dynamically as ports are added or closed. Such dynamic updates allow the user device 40 to keep current on which ports are currently being listened to and which ports are not, and thus, prevents unwanted or unimportant messages from needlessly awakening the user device 40 from the sleep mode. Additionally, since the WLAN chip knows which specific ports the user device 40 is listening to, fewer ports are open to the outside, thereby enhancing security.

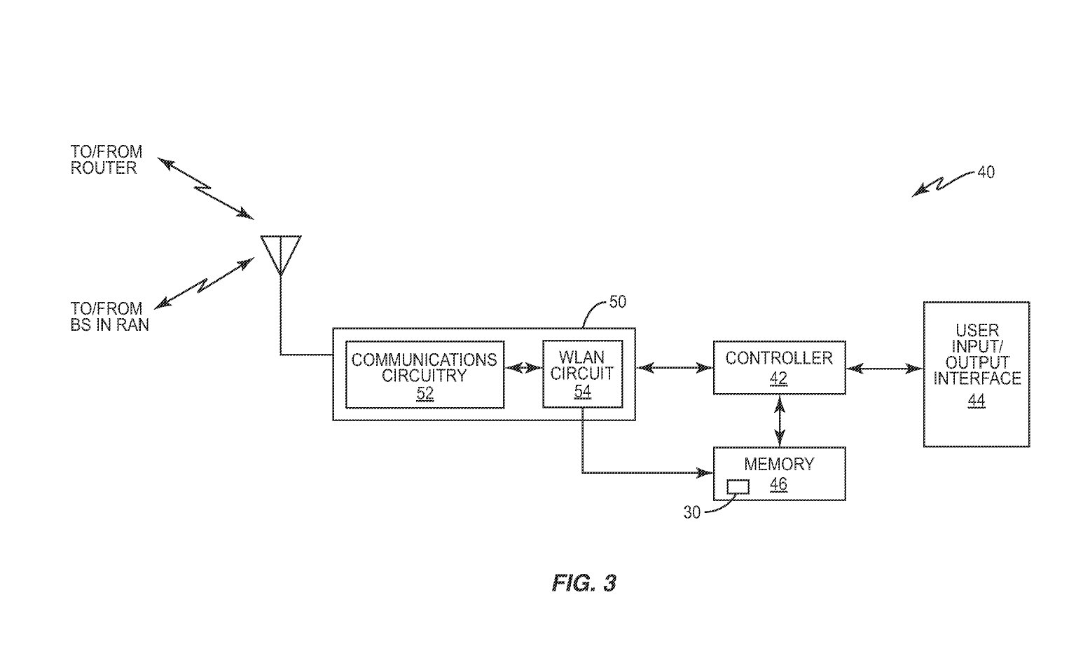

FIG. 3 is a block diagram illustrating some component parts of a user device 40 configured to operate according to one embodiment of the present invention. As previously stated, the user device 40 is used for illustrative purposes; however, the components of FIG. 3 are generic to all user devices configured to operate in accordance with the present invention.

As seen in FIG. 3, user device 40 comprises a controller 42, a user I/O interface 44, a memory 46, and a communications interface 50. The controller 42 comprises one or more programmable microprocessors configured to control the user device 40 according to logic and instructions stored in memory 46. Such control includes the control of conventional functions, such as user I/O and communications functions, but also includes the control of identifying, maintaining, and informing the WLAN chip 54 at device 40 of which allowed ports it expects to receive data from WAP 12. Specifically, the controller 42 generates and registers the one or more event listener objects as is known in the art and then stores those ports in the allowed list 48 in memory 46. As described in more detail later, the controller 42 may also send the list directly to the WLAN chip 54.

In addition to these functions, the controller 42 may, from time-to-time, generate a signal to place certain unneeded circuits into the sleep mode or low-power mode to prevent those circuit from needlessly drawing current from the battery. The controller 42 is also configured to generate other signals to wake those sleeping circuits whenever the controller 42 receives an indication to perform some function. Such indications may comprise, for example, a user action such as a key press. Additionally, however, such indications may also comprise messages received by the WLAN chip 54. According to one embodiment of the present invention, the controller 42 will only receive certain messages from the WLAN chip 54. Specifically, only those messages that are received by the WLAN chip 54 from WAP 12 over a port having a registered listener.

The User I/O Interface (UI) 44 generally includes one or more components that permit the user to interact with, and control the operation of, user device 40. Although not specifically shown in the figures, such components generally include a speaker, a microphone, a display, a camera, and one or more user controls, which may comprise a variety of knobs, switches, keys, button controls, or dials, for example. Many of these components are not specifically required for the operation of user device 40 during idle periods. Therefore, controller 42 may be configured to generate the appropriate control signals to place some or all of these components into a sleep mode or low-power mode, and to awaken them when the need arises.

Memory 46 is a computer readable medium representing the entire hierarchy of memory in the user device 40, and may comprise both random access memory (RAM) and read-only memory (ROM). Memory 46 may be implemented, for example, as one or more discrete devices, stacked devices, or removable devices, such as a flash drive or memory stick, or may be integrated with controller 42. As previously stated, the computer program instructions and data required for operation of the user device 40 are stored in non-volatile memory, such as EPROM, EEPROM, and/or flash memory. Additionally, the memory 46 may store the list 48 of allowed ports provided by controller 42. Upon receiving messages from the WAP 12, either the controller 42 or the WLAN circuit 54 may access the list to determine whether to wake the user device 40.

The communications interface 50 comprises any known interface that permits the user of user device 40 to communicate and exchange data with one or more remote parties and/or wired devices in IP network 12. The communications interface 50 may comprise, for example, communications circuitry 52, which may comprise a cellular transceiver and/or a short-range transceiver, and a WLAN chip 54. As is known in the art, the cellular transceiver, if provided, could be a fully functional cellular radio transceiver that operates according to any known standard, including Global System for Mobile Communications (GSM), TIA/EIA-136, cdmaOne, cdma2000, UMTS, and Wideband CDMA. The short-range transceiver would be configured to transmit signals to, and receive signals from, the WAP 12 via a short-range interface. In one embodiment, the communications circuitry 52 comprises a BLUETOOTH transceiver or Wi-Fi transceiver operating according to the IEEE 802.xx family of standards.

The WLAN chip 54 is a hardware circuit configured to receive messages from the WAP 12. Specifically, the WLAN chip 54 listens to predetermined ports on user device 40 for data sent by the WAP 12. The WLAN chip 54 is configured, according to one embodiment of the present invention, to “filter” these incoming messages to prevent undesired or needed messages from propagating through to the controller 42. More specifically, the WLAN chip 54 identifies the port over which a message is received from WAP 12 and compares the determined port identity to the ports on the list of allowed ports 48. The WLAN chip 54 may access the list 48 in memory 46, for example, or access the list 48 stored in its own cache, for example. If the port is on the list 48, the WLAN chip 54 allows the message to propagate through to the controller 42, which then generates the wake-up signal as previously described. If the port is not on the list 48, the WLAN chip 54 simply discards the incoming message. That is, the WLAN chip 54 does not allow the message to pass through to the controller 42 thereby preventing the controller 42 from generating a wake-up signal to needlessly awaken the user device 40.

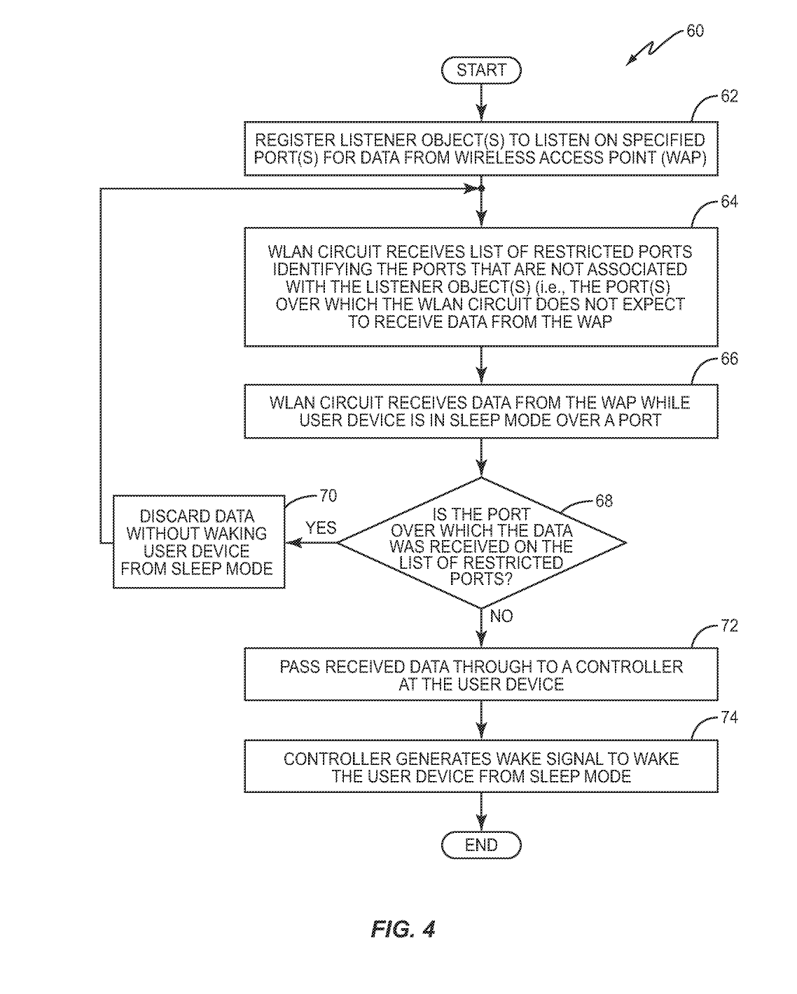

The present invention may, of course, be carried out in other ways than those specifically set forth herein without departing from essential characteristics of the invention. For example, FIG. 4 is a flow diagram illustrating a method 70 of performing the present invention according to another embodiment. Specifically, the previous embodiment utilized a list of allowed ports to filter access to the controller 42. Only messages received over the ports identified on the list were passed through to the controller 42 while the others were discarded. In this embodiment, however, the list 48 comprises a list of restricted ports over which the controller 42 does not expect to receive data from WAP 12.

Method 60 begins with the user device 40 creating and registering one or more event listener objects (box 62). Once the event listeners are registered, the WLAN chip 54 at the user device 40 is sent a list identifying all ports on user device 40 that are not being monitored by the registered listener objects (box 64). These are the ports over which the user device 40 does not expect to receive data from the WAP 12. Thereafter, the user device 40 enters the sleep mode. Upon receiving a message from WAP 12, the WLAN chip at the “sleeping” user device 40 intercepts the message prior to the controller 42 processing the message (box 66). Particularly, the WLAN chip determines the identity of the port over which the message was received and compares the port identity to the list of “restricted” port identities 48 stored in memory 46 at the user device 40 (box 68). If the port identity is on the list of restricted ports 48, the WLAN chip 54 simply discards the message without passing the message through to the device controller for processing (box 70) and awaits the next message from WLAN 12 (box 66). However, if the port identity is not on the list of restricted ports 48 (box 68), the WLAN chip 54 sends the data through to controller 42 for further processing (box 72). Upon receipt of the message, the controller 42 generates a signal to “wake-up” the “sleeping circuits” of the user device 40 from the sleep mode (box 74). Once awakened, the user device 40 processes the message appropriately.

Similar to the list of allowed ports, the list of restricted ports is kept in memory 46 and may change dynamically as ports are added or removed from the list. These updates allow the user device 40 to keep current on which ports are currently being listened to and which ports are not, and thus, prevents user device 40 from being needlessly awakened from the sleep mode by unimportant or undesired messages. This “filtering” allows the user device 40 to reduce its power consumption by awakening only for messages that it needs to process. Additionally, fewer ports are open to the outside thereby enhancing security.

Therefore, the present embodiments are to be considered in all respects as illustrative and not restrictive, and all changes coming within the meaning and equivalency range of the appended claims are intended to be embraced therein.

1-20. (canceled)

21. A method for reducing power consumption in a wireless user device, the method comprising:
generating, at a controller of the user device, a list of one or more allowed ports identifying ports over which the user device will listen for incoming data from a Wireless Access Point (WAP);
receiving the generated list of allowed ports at a Wireless Local Area Network (WLAN) circuit at the user device;
storing the list of one or more allowed ports over which the use device is configured to communicate data with the WAP;
determining whether a port over which the user device receives data from the WAP is on the list of allowed ports; and
waking the user device from a sleep mode if the port is on the list of allowed ports.

22. The method of claim 21 further comprising dynamically updating the list of allowed ports.

23. The method of claim 21 further comprising:
discarding the data received over the port if the port is not on the list of allowed ports; and
leaving the user device to operate in the sleep mode after discarding the data.

24. The method of claim 21 further comprising:
identifying the port over which the incoming data is received from the WAP; and
filtering the incoming data by comparing the identity of the port to the one or more ports on the list of allowed ports.

25. A user device for communicating with remote devices in a Wireless Local Area Network (WLAN), the user device comprising:
a programmable controller configured to generate a list of allowed ports identifying one or more ports over which the user device will listen for incoming data from a Wireless Access Point (WAP);
a memory configured to store a list of the allowed ports;
a communications interface configured to communicate data with the WAP over the one or more allowed ports; and
a WLAN circuit configured to:
receive the generated list of allowed ports from the controller;
determine whether a port over which the user device received data from the WAP is on the list of allowed ports stored in the memory; and
wake the user device from a sleep mode if the port is on the list.

26. The user device of claim 25 wherein the programmable controller is further configured to dynamically update the list of allowed ports.

27. The user device of claim 25 wherein the WLAN circuit is further configured to:
discard the data received over the port if the port is not on the list of allowed ports; and
leave the user device to operate in the sleep mode after discarding the data.

28. The user device of claim 25 wherein the WLAN circuit is further configured to:
identify the port over which the incoming data is received from the WAP; and
filter the incoming data by comparing the identity of the port to the one or more ports on the list of allowed ports.

29. A method of reducing power consumption in a wireless user device, the method comprising:
generating, at a user device, a list identifying one or more restricted ports over which the user device will not listen for incoming data from a Wireless Access Point (WAP);
receiving the generated list at a Wireless Local Area Network (WLAN) circuit at the user device;
identifying a port over which the incoming data is received from the WAP;
filtering the incoming data by comparing the identity of the port over which the incoming data is received from the WAP to the one or more restricted ports on the list;
discarding received data if the port over which the data is received is on the list of restricted ports; and
leaving the user device in the sleep mode after discarding the data.

30. The method of claim 29 further comprising waking the user device from a sleep mode responsive to receiving the data from the WAP if the port is not on the list.

31. The method of claim 29 wherein generating, at a user device, a list identifying one or more restricted ports over which the user device does not listen for incoming data comprises dynamically generating the list of restricted ports based on one or more ports that are not associated with a registered listener.

32. A user device for communicating with remote devices in a Wireless Local Area Network (WLAN), the user device comprising:
a memory configured to store a list of restricted ports that identifies one or more ports over which the user device will not listen for data from the Wireless Access Point (WAP); and
a programmable controller configured to:
dynamically generate the list of restricted ports based on one or more ports that are not associated with a registered listener;
discard received data if the data is received from the WAP over a port that is on the list of restricted ports; and
leave the user device in the sleep mode after discarding the data; and
a Wireless Local Area Network (WLAN) circuit configured to:
receive the dynamically generated list of restricted ports from the programmable controller;
identify the port over which the data is received from the WAP; and
filter the data by comparing the identity of the port that received the data to the ports on the list of restricted ports.

33. The user device of claim 32 wherein the programmable controller is further configured to wake the user device from a sleep mode if the port over which the user device received the data is not on the list of restricted ports.
